(19) United States
(12) Patent Application Publication
(10) Pub. No.: US 2016/0336629 A1
(43) Pub. Date: Nov. 17, 2016

(54) BATTERY MODULE

(71) Applicant: SAMSUNG SDI CO., LTD., Yongin-si (KR)

(72) Inventors: Man-Sik CHO, Yongin-si (KR); Sun-Hye HU, Yongin-si (KR)

(21) Appl. No.: 15/145,827

(22) Filed: May 4, 2016

(30) Foreign Application Priority Data
May 14, 2015 (KR) 10-2015-0067485

(51) Int. Cl. H01M 10/6566; H01M 2/10; H01M 10/613; H01M 10/6556

(52) U.S. Cl. CPC H01M 10/6566; H01M 10/6556; H01M 2/105; H01M 10/613

(57) ABSTRACT

A battery module, including a plurality of rechargeable batteries; and a plurality of holders made from an insulating material, the plurality of holders including receiving spaces for receiving the rechargeable batteries, and the plurality of holders including a cooling passage in the receiving spaces.

### CROSS-REFERENCED TO RELATED APPLICATION

Korean Patent Application No. 10-2015-0067485, filed on May 14, 2015, in the Korean Intellectual Property Office, and entitled: “Battery Module,” is incorporated by reference herein in its entirety.

### BACKGROUND

1. Field

The described technology relates to a battery module.

2. Description of the Related Art

A rechargeable battery may differ from a primary battery in that a rechargeable battery may be repeatedly charged and discharged, while a primary battery may be incapable of being recharged. Rechargeable batteries may be classified as a low-capacity rechargeable battery or a large-capacity rechargeable battery.

### SUMMARY

Embodiments may be realized by providing a battery module, including a plurality of rechargeable batteries; and a plurality of holders made from an insulating material, the plurality of holders including receiving spaces for receiving the rechargeable batteries, and the plurality of holders including a cooling passage in the receiving spaces.

The receiving space may have a hollow shape, and opposite ends of the hollow shape may be open.

Each holder may include a plurality of support ribs at an inner wall surface of the holder along a length direction of each rechargeable battery, the plurality of support ribs supporting an external surface of the rechargeable battery.

Each of the support ribs may be integrally formed with and protrude from the inner wall surface of the holder, and each of the support ribs may contact the external surface of the rechargeable battery along the length direction of the rechargeable battery.

The support ribs may be disposed as respective pairs at the inner wall surface of the holder such that the support ribs are symmetrical to each other.

The support ribs may protrude from the inner wall surface of the holder and may have a semicircular cross-sectional shape.

The cooling passage may be formed by the support ribs and may have a fixed interval between the inner wall surface of the holder and the external surface of the rechargeable battery.

The cooling passage may be divided by the support ribs to form a plurality of cooling passages between the inner wall surface of the holder and the external surface of the rechargeable battery.

At least one pair of the holders may be integrally connected, and may be connected to overlap the support ribs of holders neighboring each other.

The holder may include a plurality of air guide grooves that are at the inner wall surface between the support ribs along a length direction of the holder.

The cooling passage may be connected to an air supply source.

Each holder may be made from a plastic material.

Each rechargeable battery and holder may have corresponding cylindrical shapes.

### BRIEF DESCRIPTION OF THE DRAWINGS

Features will become apparent to those of skill in the art by describing in detail exemplary embodiments with reference to the attached drawings in which:

FIG. 1 illustrates a partial perspective view of a battery module according to an exemplary embodiment;

FIG. 2 illustrates a partial side view of the battery module according to the exemplary embodiment;

FIG. 3 illustrates a drawing of an assembled structure of a holder applicable to the battery module according to the exemplary embodiment;

FIG. 4 illustrates a drawing of another assembled structure of the holder applicable to the battery module according to the exemplary embodiment;

FIG. 5 and FIG. 6 illustrate longitudinal cross-sectional views of the battery module according to the exemplary embodiment; and

FIG. 7 illustrates a cross-sectional view of a battery module according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

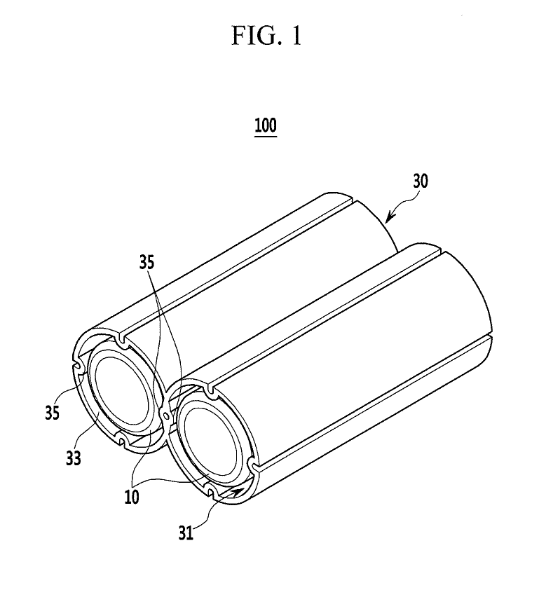

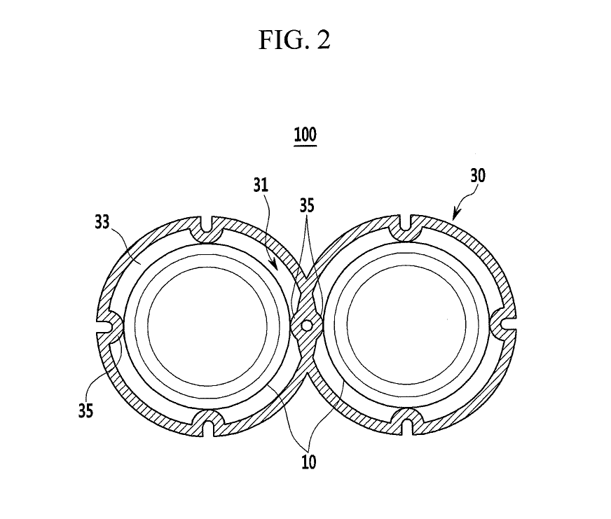

FIG. 1 illustrates a partial perspective view of a battery module according to an exemplary embodiment, and FIG. 2 illustrates a partial side view of the battery module according to the exemplary embodiment.

Referring to FIGS. 1 and 2, the battery module 100 according to the exemplary embodiment may be a collection of rechargeable batteries requiring high power, and may be referred to as a “battery pack” in the related art.

For example, the battery module 100 may be applied as a pack type to home appliances such as a cordless cleaner. However, embodiments may be applied to any power supply that may be charged and discharged and may be adopted by various kinds of electrical appliances, hybrid vehicles, and electric vehicles.

The battery module 100 according to the exemplary embodiment may have a structure in which an overall volume may be minimized and a heat dissipation characteristic of the rechargeable battery may be improved.

For this purpose, the battery module according to the exemplary embodiment 100 may basically include a plurality of rechargeable batteries 10 and a plurality of holders 30 for protecting the respective rechargeable batteries 10.

The rechargeable 10 battery according to the exemplary embodiment may be a unit cell or a unit battery, and may have a cylindrical shape, for example. The rechargeable battery 10 may include: an electrode assembly installed to be inserted into the housing and having positive and negative electrodes; a cap plate combined to an opening of the housing; and terminals protruding out of the housing. In the exemplary embodiment, a cylindrical rechargeable battery is described as an example. In an embodiment, the rechargeable battery may have a prismatic or other shape.

In an embodiment, the rechargeable battery 10 may be connected in series to a neighboring rechargeable battery 10 via a bus bar. In an embodiment, the rechargeable batteries may be freely connected in series or in parallel.

The rechargeable batteries 10 having the circular cylindrical shape may be disposed with their top and bottom sides alternately arranged. For example, a positive electrode terminal may be disposed at one end portion of the rechargeable battery 10 in a height direction thereof, and a negative terminal may be disposed at the other end portion in the height direction thereof. One rechargeable battery 10 may be disposed such that a positive electrode terminal is directed upward, and the other rechargeable battery may be disposed such that a negative terminal is directed upward.

A plurality of holders 30 according to the exemplary embodiment may be provided, and respectively accommodate the rechargeable batteries 10 such that the rechargeable batteries 10 may be treated as a cell assembly. The holder 30 may serve to protect the rechargeable battery 10 from an external force, as well as to enclose and fix the entire rechargeable battery 10 in the length direction thereof.

For example, the holder 30 may be made of an electrically insulating material, for example, a plastic material. Thus, the holders 30 may support the rechargeable batteries 10, suppress the rechargeable batteries 10 from being shorted, and prevent the rechargeable battery 10 from being scratched.

For example, the holder 30 may have a cylindrical shape in accordance with an external shape of the rechargeable battery 10. The holder 30 may include a hollow receiving space 31 with a length corresponding to the length of the rechargeable battery 10 and with its opposite ends open.

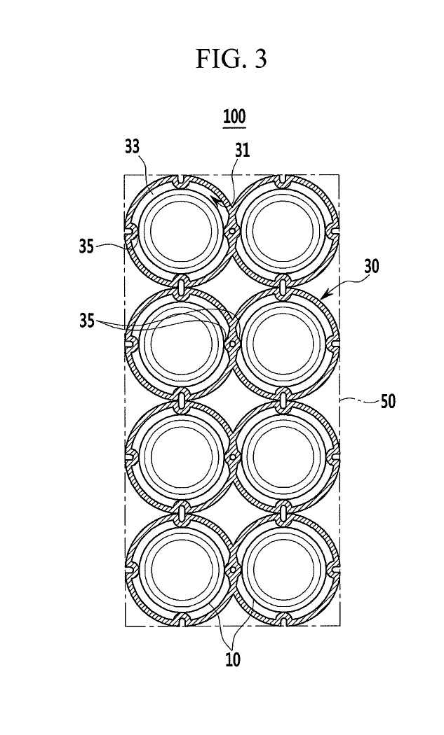

These holders 30 may be provided as an assembly in which the holders 30 for respectively accommodating the rechargeable batteries may be integrally connected as pairs, and as shown in FIG. 3, a plurality of assemblies described above may be repeatedly arranged inside a battery module case 50.

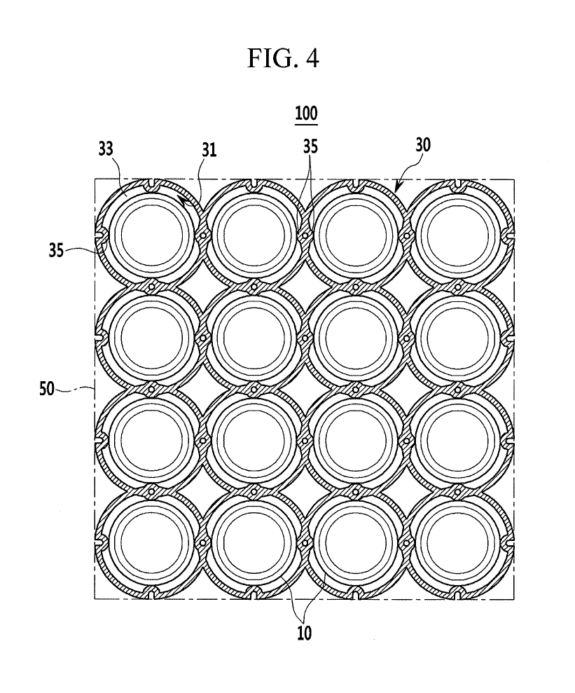

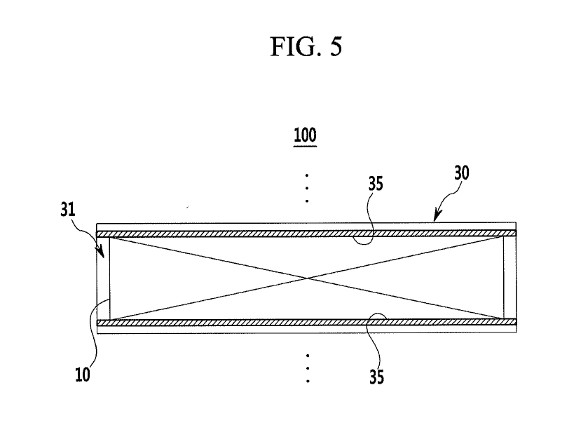

A plurality of holders 30 accommodating the respective rechargeable batteries 10 may be provided, as shown in FIG. 4, as a single cell assembly in which the plurality of holders 30 may be mutually integrally connected, and may be accommodated in the battery module case 50. The cell assembly of the holders 30 may be integrally connected with the battery module case 50.

In the exemplary embodiment, the holder 30 may create, as shown in FIGS. 1 and 2, a cooling passage 33, e.g., an air-flowing cooling passage 33, in the receiving space 31. Air means cooling air at room temperature or below for air-cooling heat generated from the rechargeable batteries.

The cooling passage 33 may create a cooling air stream and may be provided between an external circumferential surface of the rechargeable battery 10 and an inner circumferential surface of the holder 30 along the length direction of the rechargeable battery 10 and the holder 30.

In order to create the cooling passage 33 as described above, the holder 30 according to the exemplary embodiment may include a plurality of support ribs 35 that may be formed at an inner wall surface along the length direction of the rechargeable battery 10.

The support ribs 35 may be formed at the inner wall surface of the holder 30 and may extend along the length direction thereof, and may serve to support the external surface of the rechargeable battery 10 and prevent the holder 30 from being contracted or expanded by heat generated from the rechargeable battery 10 or an external force.

The support rib 35 may be integrally formed with and protrude from the inner wall surface of the holder 30 along the length direction of the rechargeable battery 10. The support ribs 35 may be formed to protrude from the inner wall surface of the holder 30 and may have the same length. The support ribs 35 may contact, e.g., may make line contact with, the external surface of the rechargeable battery 10 in the length direction thereof, and may support the external surface of the rechargeable battery 10.

For example, the support rib 35 may be concavely formed from the external surface of the holder 30 to inward of the receiving space 31, and the support rib 35 may be formed to protrude from the inner wall surface of the holder 30 to an inner center of the receiving space 31. The support rib 35 may be formed to protrude from the inner wall surface of the holder 30 and may have a substantially semicircular cross-sectional shape. The support rib 35 may have a center portion of a semicircular arc that may contact, e.g., may make line contact with, the external surface of the rechargeable battery 10 along the length direction thereof.

Respective pairs of support ribs 35 may be disposed at the inner wall surface of the holder 30 such that the respective pairs of support ribs 35 are symmetrical to each other, for example, may be disposed at intervals of 90 degrees based on the inner center of the receiving space 31, and four support ribs 35 may be formed at the inner wall surface of each of the holders 30.

In an embodiment, four support ribs 35 may be formed at the inner wall surface of the holder 30 at the intervals of 90 degrees. In an embodiment, two support ribs 35 at an interval of 180 degrees, three support ribs 35 at intervals of 120 degrees, or more may be radially arranged based on the inner center of the receiving space 31.

Since the support ribs 35 for supporting the external surface of the rechargeable battery 10 may be formed at the inner wall surface of the holder 30, in the exemplary embodiment, the cooling passage 33 as described above may be provided between the inner wall surface of the holder 30 and the external surface of the rechargeable battery 10 by the support ribs 35.

The cooling passage 33 may be divided by the support ribs 35 to form a plurality of cooling passages 33 between the inner wall surface of the holder 30 and the external surface of the rechargeable battery 10. For example, the cooling passage 33 may be divided such that the number of cooling passages 33 corresponding to the number of support ribs 35 may be formed between the inner wall surface of the holder 30 and the external surface of the rechargeable battery 10.

The respective cooling passages 33 may be divided by the support ribs 35 such that the respective cooling passages 33 may be formed between the inner wall surface of the holder 30 and the external surface of the rechargeable battery 10 while having a fixed interval therebetween.

The support ribs 35 may protrude toward the center of the receiving space 31 from the inner wall surface of the holder 30 while having a fixed length and may contact, e.g., may make line contact with, the external surface of the rechargeable battery 10, and the cooling passages 33 may be divided to be formed between the inner wall surface of the holder 30 and the external surface of the rechargeable battery 10 while having the fixed interval therebetween. The cooling passages 33 may be formed between the inner wall surface of the holder 30 and the external surface of the rechargeable battery 10 to have a flow cross-section, and may circulate a predetermined rate of cooling air.

These cooling passages 33 may generate a cooling air stream between the inner wall surface of the holder 30 and the external surface of the rechargeable battery 10 to discharge the heat generated from the rechargeable battery 10.

The cooling passage 33 may be connected to an air supply source 70, and may circulate the cooling air that is supplied from the air supply source 70. The air supply source 70 may be installed in devices to which the battery module 100 may be applied. For example, the air supply source 70 may include one of an air supply fan assembly that takes in air to supply to the cooling passage 33, an air pump, an air blower, and an air compressor.

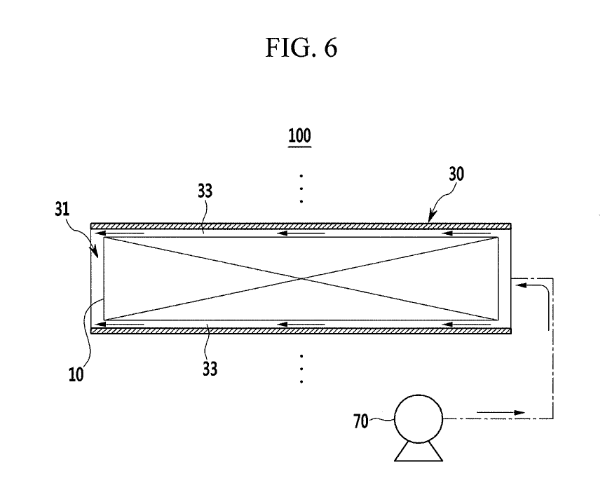

The cooling air provided from the air supply source 70 may be introduced, as shown in FIG. 6, to the cooling passage 33 from one end of the holder 30. The cooling air may circulate along the cooling passage 33, and may be discharged to, e.g., from, the other end of the holder 30 after cooling the heat generated from the rechargeable battery 10.

According to the exemplary embodiment, at least one pair of holders 30 may be connected to overlap the support ribs 35 of the neighboring holders 30 since the holders 30, e.g., at least one pair of holders 30, may be integrally connected as previously described with reference to FIGS. 3 and 4. The holders 30 may be formed by an injection method, and at least one pair may be integrally connected.

Each of the holders 30 of one pair neighboring each other may be integrally connected, as shown in FIG. 3, and the support ribs 35 facing each other may be connected to overlap each other.

The holders 30 may be mutually integrally connected to each other and may be configured as a single cell assembly, as shown in FIG. 4, and the support ribs 35 facing each other in four directions may be connected to overlap each other.

According to the battery module according to the exemplary embodiment 100 configured as described above, the rechargeable batteries 10 may be charged and discharged by a large amount of current, and heat associated with internal reaction may be generated in the rechargeable batteries 10.

In the exemplary embodiment, the cooling air may be circulated from one end of the holder 30 to the cooling passage 33 via the air supply source 70 between the inner wall surface of the holder 30 and the external surface of the rechargeable battery 10.

Subsequently, the cooling air may be circulated via the cooling passages 33 that may be separately divided by the support ribs 35 of the holder 30, and may be discharged via the other end of the holder 30, and heat generated from the rechargeable battery 10 may be discharged.

According to the above-described battery module 100 according to the exemplary embodiment, the holders 30 for supporting the rechargeable batteries 10 may be formed from a plastic insulating material, and the rechargeable batteries 10 may be suppressed from being shorted and prevented from being scratched by an external force.

In the exemplary embodiment, the support ribs 35 for supporting the external surface of the rechargeable battery 10 may be formed at the inner wall surface of the holder 30 and may extend along the length direction thereof, and the holder 30 may be prevented from being deformed by contraction or expansion caused by the heat, internal pressure, or external force generated from the rechargeable battery 10.

In the exemplary embodiment, the support ribs 35 may contact, e.g., may make line contact with, the external surface of the rechargeable battery 10 and create the cooling passages 33 between the external surface of the rechargeable battery 10 and the inner wall surface of the holder 30, a maximum space for the cooling passage 33 may be secured for each of the rechargeable batteries 10, and a flow rate of the cooling air may be increased.

In the exemplary embodiment, the support ribs 35 may create the cooling passages 33 having the fixed intervals therebetween between the inner wall surface of the holder 30 and the external surface of the rechargeable battery 10, and the heat generated from the rechargeable battery 10 may be uniformly dissipated via the cooling air flowing at a constant flow rate along the cooling passages 33.

In the exemplary embodiment, the flow rate of the cooling air for each of the rechargeable batteries 10 may be increased and the cooling air may be allowed to flow at the constant flow rate, heat dissipation performance of the entire battery module may be maximized, and a service life of rechargeable batteries 10 may be further extended.

In the exemplary embodiment, the support ribs 35 of the holders 30 facing each other may be connected to overlap each other, a volume of the entire battery module 100 may be reduced, and a limited receiving space of the battery module case for accommodating the holders 30 may be maximally used as the moving passage of the cooling air.

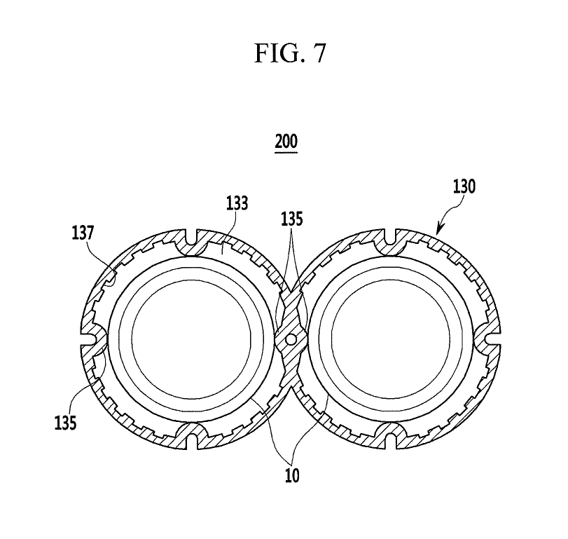

FIG. 7 illustrates a cross-sectional view of a battery module according to an exemplary embodiment.

Referring to FIG. 7, in the battery module 200 according to the current exemplary embodiment, based on the structure of the aforementioned exemplary embodiment, a holder 130 in which a plurality of air guide grooves 137 may be formed at an inner wall surface between support ribs 135 in a length direction may be configured.

In the exemplary embodiment, the air guide grooves 137 may be formed at the inner wall surface between the support ribs 135 of the holder 130 such that the air guide grooves 137 may extend from one end to the other end along the length direction of the holder 130.

The air guide grooves 137 may be disposed at the inner wall surface between the support ribs 135 and may be separated by a fixed interval therebetween along an inner circumferential direction.

According to the battery module 200 configured as described above in accordance with the current exemplary embodiment, the air guide grooves 137 may be formed at the inner wall surface between the support ribs 135 of the holder 130 in the structure of the exemplary embodiment described above, and cooling air may be smoothly introduced from one end of a cooling passage 133 to the other end thereof via the air guide grooves 137.

In the current exemplary embodiment, the air guide grooves 137 may be formed at the inner wall surface of the holder 130 in the cooling passage 133 between the external surface of the rechargeable battery 10 and the inner wall surface of the holder 130, and a flow rate of the cooling air moving along the cooling passage 133 may be further increased.

As described above, the other configurations and effects of the battery module according to the current exemplary embodiment 200 may be the same as those of the aforementioned exemplary embodiment, and a more detailed description thereof will be omitted.

By way of summation and review, low-capacity rechargeable batteries may be used in small portable electronic devices such as mobile phones, laptop computers, cameras, and camcorders. High-capacity rechargeable batteries (heretofore referred to as a “battery module”) may be used in home appliances such as a cordless cleaner, and may be further used as a power source for driving a motor of, for example, a hybrid electric vehicle (HEV) or an electric vehicle (EV).

A single high-capacity battery module may include a plurality of rechargeable batteries that may be connected in series, and a rechargeable battery may be formed in a cylindrical or prismatic shape.

The battery module may be configured as one module by connecting several or tens of rechargeable batteries, and heat of reaction generated from each of the rechargeable batteries should be easily discharged.

A heat dissipation characteristic of the battery module may be a major factor for determining performance of the battery module, and when heat is not properly dissipated, the generated heat may increase an internal temperature of the rechargeable battery, and in an extreme case, a malfunction of the device to which the battery module may be applied may occur or an explosion risk may be present, for example, due to overheating.

For example, a large amount of current may be charged and discharged to a large capacity battery module requiring high power, and heat of reaction may be generated by internal reactions of the rechargeable batteries depending on their use state and may increase to a considerable temperature, which may affect an intrinsic characteristic of the rechargeable battery and may deteriorate intrinsic performance of the battery module.

The battery module may include a cooling structure, a safety means, and a system circuit for allowing heat generated from each of the rechargeable batteries to be easily discharged, and an overall volume of the battery module may be increased. A method of reducing a gap between the rechargeable batteries included in the battery module may be used to reduce the volume, and heat generated from the rechargeable batteries may not be easily dissipated.

For a high capacity battery module requiring high power, it may be very crucial to develop a battery assembly structure that may be capable of minimizing an overall volume of the rechargeable battery and improving a heat dissipation characteristic thereof.

The described technology relates to a battery module that may have an improved holder structure for supporting high-power rechargeable batteries.

Provided is a battery module in which an overall volume may be minimized and heat dissipation performance of rechargeable batteries may be improved with a simple configuration.

According to the battery module according to the exemplary embodiments as described above, the support ribs may be formed at the inner wall surface of the holder for accommodating the rechargeable batteries, the overall volume of the battery module may be minimized and the heat dissipation performance of the rechargeable batteries may be maximized, and a service life of the rechargeable batteries may be further extended.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of rechargeable batteries; and
a plurality of holders made from an insulating material, the plurality of holders including receiving spaces for receiving the rechargeable batteries, and the plurality of holders including a cooling passage in the receiving spaces.

2. The battery module as claimed in claim 1, wherein:
the receiving space has a hollow shape, and
opposite ends of the hollow shape are open.

3. The battery module as claimed in claim 1, wherein each holder includes a plurality of support ribs at an inner wall surface of the holder along a length direction of each rechargeable battery, the plurality of support ribs supporting an external surface of the rechargeable battery.

4. The battery module as claimed in claim 3, wherein each of the support ribs is integrally formed with and protrudes from the inner wall surface of the holder, and each of the support ribs contacts the external surface of the rechargeable battery along the length direction of the rechargeable battery.

5. The battery module as claimed in claim 4, wherein the support ribs are disposed as respective pairs at the inner wall surface of the holder such that the support ribs are symmetrical to each other.

6. The battery module as claimed in claim 4, wherein the support ribs protrude from the inner wall surface of the holder and have a semicircular cross-sectional shape.

7. The battery module as claimed in claim 3, wherein the cooling passage is formed by the support ribs and has a fixed interval between the inner wall surface of the holder and the external surface of the rechargeable battery.

8. The battery module as claimed in claim 7, wherein the cooling passage is divided by the support ribs to form a plurality of cooling passages between the inner wall surface of the holder and the external surface of the rechargeable battery.

9. The battery module as claimed in claim 3, wherein at least one pair of the holders is integrally connected, and is connected to overlap the support ribs of holders neighboring each other.

10. The battery module as claimed in claim 3, wherein the holder includes a plurality of air guide grooves that are at the inner wall surface between the support ribs along a length direction of the holder.

11. The battery module as claimed in claim 1, wherein the cooling passage is connected to an air supply source.

12. The battery module as claimed in claim 1, wherein each holder is made from a plastic material.

13. The battery module as claimed in claim 1, wherein each rechargeable battery and holder have corresponding cylindrical shapes.
